(19) United States
(12) Patent Application Publication
(10) Pub. No.: US 2026/0171289 A1
(43) Pub. Date: Jun. 18, 2026

(54) ELECTRONIC DEVICE AND ELECTRONIC MODULE

(71) Applicant: COMMISSARIAT A L'ENERGIE ATOMIQUE ET AUX ENERGIES ALTERNATIVES, Paris (FR)

(72) Inventors: Gaëtan PEREZ, Grenoble Cedex 09 (FR); Cédric MASANTE, Grenoble Cedex 09 (FR); Philippe GODIGNON, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/422,032

(22) Filed: Dec. 16, 2025

(30) Foreign Application Priority Data
Dec. 17, 2024 (FR) FR2414315

(51) Int. Cl. H01C 7/00; H01C 1/08

(52) U.S. Cl. CPC H01C 7/008; H01C 1/08

(57) ABSTRACT

An electronic device, comprising a component having a resistance with a negative temperature coefficient, and a temperature control means having an electrical resistance varying according to the temperature, such that the sum of the total resistance is, over a second temperature subrange greater than a setpoint temperature strictly greater than the total resistance at the setpoint temperature

### TECHNICAL FIELD

The technical field of the invention relates to electronic devices, such as those being able to be used in an electronic circuit for power components. The technical field also relates to assemblies of these devices, in the form of electronic modules.

### PRIOR ART

The document [G. Perez et al., “Diamond semiconductor performances in power electronics applications”, Diamond and Related Materials, Volume 110, 2020, 108154, ISSN 0925-9635, https://doi.org/10.1016/j.diamond.2020.108154] describes an electronic component, in particular, a Schottky diode made from a wide band gap (WBG) semiconductor material, and in this case, diamond, as well as problems with paralleling this type of component.

The Schottky diode described has, in the on state, a variation of resistance according to the non-monotone temperature with a minimum resistance value for a temperature of 640K. The Schottky diode has, between the ambient temperature and 640K, a negative temperature coefficient (NTC), i.e. that the resistance decreases according to the temperature. The Schottky diode also has, for a temperature greater than 640K, a positive temperature coefficient (PTC). In other words, the resistance increases as the temperature increases.

The authors indicate that the negative temperature coefficient can lead to a self-heating, which leads to the Schottky diode increasing its temperature, as its resistance decreases, until reaching an equilibrium temperature around 640K. This self-heating phenomenon thus makes it possible to benefit from a Schottky diode which, in its on state, has a minimum resistance.

However, for certain electronic components having a negative temperature coefficient, the equilibrium temperature can be too high to enable their integration. As an example, this temperature can be greater than the damage temperature of its protective housing. Therefore, it is necessary to control the maximum temperature reached by the operating electronic component.

To control the temperature of a component with negative temperature coefficient, G. Perez et al. suggest coupling the latter with a heat sink. In this way, the heat dissipated by the component is discharged and the self-heating is controlled. The authors however note that the size of the heat sink increases as the targeted operating temperature decreases. In addition, the miniaturisation of the electronic components is difficult to be compatible with an increase of the size of the sinks. This solution has therefore proved to be limited, in practice.

There is therefore a need to provide a means for controlling the temperature of an electronic component with a negative temperature coefficient.

### SUMMARY

To achieve this aim, the invention provides an electronic device comprising an electronic component, said electronic component having a resistance, said resistance having, for a temperature range, a negative temperature coefficient, said temperature range comprising a setpoint temperature dividing said temperature range into two temperature subranges, of which:
a. a first temperature subrange corresponding to the temperatures of the temperature range, less than or equal to the setpoint temperature; and
b. a second temperature subrange corresponding to the temperatures of the temperature range, strictly greater than the setpoint temperature.

The electronic device is noteworthy, in that it comprises a thermistor, electrically connected in series with the electronic component and thermally coupled to the electronic component, the thermistor having an electrical resistance, varying according to the temperature, such that the total electrical resistance of the electronic device, comprising the sum of the electrical resistance of the electronic component, and of the electrical resistance of the thermistor, is, over the second temperature subrange, strictly greater than the total electrical resistance at the setpoint temperature.

By “thermally coupled elements”, this means that the thermal resistance of the coupling between the elements is less than or equal to 1K/W.

By “thermistor”, any type of element which has a resistance with a positive temperature coefficient is expected. This is, for example, a thermistor as such, a heat resistance or also a semiconductor with a resistance which increases, according to the temperature.

The electronic component (that can be called, more simply, “component”) implemented is, for example, an electronic component such as described by the document by G. Perez et al. and presented above. The thermistor, connected in series to the component, makes it possible to add a variable resistance according to the temperature in the path of the current passing into the component. An increase of the resistance of the thermistor thus makes it possible to limit the current passing into component, and therefore to limit the heating associated with the circulation of this current in the component.

In particular, thanks to the increase of the total resistance beyond the setpoint temperature, a dichotomy is performed around the setpoint temperature. In this way, the current circulating in the component is limited when its temperature exceeds the setpoint temperature and its heating is consequently also limited. The self-heating associated with the negative temperature coefficient of the component is therefore limited, even avoided, and the temperature of the component is kept in the vicinity of the setpoint temperature.

The passive character of the thermistor enables a simplified design and implementation of the electronic component. It is not necessary to provide an additional energy to power the thermistor. The features of the thermistor are sized during its manufacture. The maintenance operations are also simplified, as it is not necessary to calibrate or recalibrate the thermistor. Thus, the electronic device can be used following a so-called “set and forget” approach.

Advantageously, the electrical resistance of the thermistor is such that the total resistance of the device increases over the second subrange.

Advantageously, the electrical resistance of the thermistor over the second temperature subrange is strictly greater than the electrical resistance of the electronic component at the setpoint temperature.

Advantageously, the electrical resistance of the thermistor over the first temperature subrange is constant or increasing.

Advantageously, the electrical resistance of the thermistor over the first temperature subrange is less than or equal to 10% of the electrical resistance of the electronic component at the setpoint temperature.

Advantageously, the thermal resistance of the thermal coupling between the thermistor and the electronic component is less than or equal to 0.01K/W.

Advantageously, the thermistor is bonded or welded or soldered or sintered on the electronic component.

Alternatively, the electronic component and the thermistor are made of one same part, for example, from one same substrate or from one same stack of layers.

Advantageously, the electronic device comprises an electrically and thermally conductive sole, the electronic component being bonded or welded or soldered or sintered on the sole, and the thermistor being bonded or welded or soldered or sintered on the sole.

Advantageously, the component is made from diamond.

In the current solutions, the paralleling of components with a negative temperature coefficient can favour, even accelerate, the self-heating, even the thermal runaway, of the electronic components, even if the latter are supposed to be identical. Indeed, there are still manufacturing disparities, even low, which mean that these electronic components are different, even slightly. The circulation of an electrical current in each of the components according to the prior art primes a self-heating of each component. Yet, the manufacturing disparities will lead to a greater heating in one of the components. The resistance reduction caused by the self-heating focuses the electrical current on the component subjected to the self-heating. The other component has a reduced electrical current, which can tend to cool or limit the heating of the latter (and increase its resistance in the case of an NTC device). The electrical current is thus highly deviated to one of the components, which can be damaged (directly, or its integration environment) or age in an accelerated manner. This is problematic in the case of paralleling two components with a negative temperature coefficient. This is particularly problematic, when these components are integrated in a circuit for power electronics. Indeed, the current in a circuit for power electronics is generally imposed by the charge of said circuit. The components cannot therefore modulate the current circulating in the circuit to limit the heating. They must share the current equitably.

To resolve this problem, the invention also provides an electronic module, comprising:
a. an electronic device according to the invention; and
b. one or more additional electronic devices, connected in parallel to said electronic device.

The paralleling of a device according to the invention with another electronic device (which is not necessarily a device according to the invention or a component having a resistance with a negative temperature coefficient) to form a module makes it possible to control the self-heating of the electronic device to limit the deviation of the current. Therefore, the module according to the invention does not risk suffering from a damaging or an accelerated ageing.

Advantageously, the electronic device and said at least one additional electronic device are thermally coupled.

Advantageously, the electronic module is a power electronics module, at least one of the electronic devices, from among the electronic device and said at least one additional electronic device, is made from diamond.

In a particularly advantageous embodiment, said at least one additional electronic device is also an electronic device according to the invention. In this way, each of the devices according to the invention implemented to limit the self-heating of one single component and the derivation of the current to this single component.

### BRIEF DESCRIPTION OF THE FIGURES

FIG. 1 represents a digital simulation result for an electrical component according to the prior art, said electronic component having a negative temperature coefficient for a temperature range.

FIGS. 2 and 3 represent first and second digital simulation results for an electronic device according to the invention.

FIG. 4 schematically represents a first embodiment of an electronic device according to the invention, said electronic device being presented without and with its protective housing.

FIG. 5 schematically represents a second embodiment of the electronic device according to the invention, said electronic device also being represented without and with its protective housing.

FIG. 6 represents an example of an equivalent electrical diagram of an electronic module according to the invention.

FIGS. 7 and 8 represent first and second digital simulation results for electronic modules according to the prior art and according to the invention.

FIG. 9 schematically represents a first embodiment of an electronic module according to the invention, said electronic module being represented without and with its protective housing.

FIG. 10 schematically represents a second embodiment of the electronic module according to the invention.

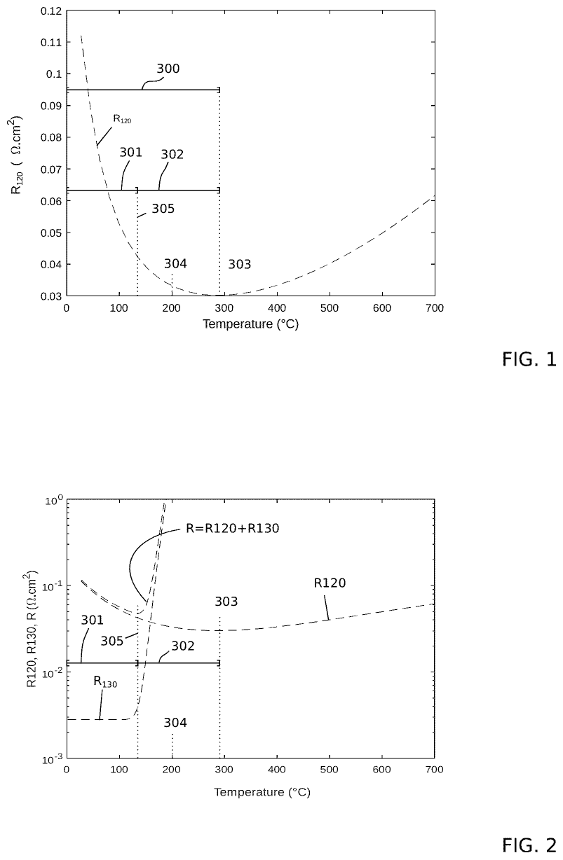

The figures are given as examples and are not limiting of the invention. They constitute principle schematic representations, intended to facilitate the understanding of the invention and are not necessarily to the scale of practical applications. In particular, FIGS. 1 to 10 are not representative of reality.

### DETAILED DESCRIPTION

The invention aims to limit the self-heating of electronic components 120. This invention advantageously falls into the field of devices adapted to power electronics, since this is a field for which the temperatures of the components can be very high.

An electronic device 100 according to the invention comprises an electronic component 120. This is, for example, a component according to the prior art, such as a junction forming a diode or a transistor. More specifically, this can be a Schottky diode made from diamond.

The component 120 is particular, in that it has, for a particular temperature range 300, an electrical resistance R120 with a negative temperature coefficient. An element, the resistance of which varies negatively according to the temperature is called “negative temperature coefficient” (to be noted that by “variation”, this means a continuous variation of a value, for example, resistance or temperature value). Such an element is, in the absence of any control means, able to be subjected to a self-heating, being able to bring, in certain cases, a thermal runaway.

The electronic device 100 according to the invention, is precisely noteworthy in that it adds a thermistor 130 to the component 120. This thermistor 130 is configured to limit the self-heating of the component 120.

FIGS. 1 and 2 represent simulation results of a device 100 according to the invention. FIG. 1 represents a result for a device, where the thermistor 130 is absent. In other words, FIG. 1 represents the performance of only the component 120. This result corresponds, for example, to a performance observable on an electronic component according to the prior art. Discussing the performance of only the component 120 makes it possible to then measure the benefit of adding the thermistor 130.

FIG. 2 represents a simulation result for the same device 100, except that the effect of the thermistor 130 is considered.

In FIGS. 1 and 2, the component 120 is modelled by a Schottky diode made from diamond. Diamond is particular, in that it has a resistance with a negative temperature coefficient. Other models had been able to be used for the component 120, such as an aluminium nitride diode (which also has a negative temperature coefficient) or a diamond- or AlN-based transistor junction. The results of FIGS. 1 and 2 are obtained, when the component 120 is in an on state.

In general, component 120 is preferably a unipolar component, also referred to as a “unipolar conduction” component. It is, for example, made of a unipolar semiconductor material. This can be, for example, diamond or aluminum nitride, as mentioned above. It may also be GaN or Ga₂O₃. By “made of a material,” it is understood that it comprises said material and possibly other materials.

In a unipolar semiconductor material, electrical conduction is dominated by a single type of charge carrier, namely electrons or holes. Conversely, in a bipolar semiconductor material, such as silicon, conduction is ensured by both types of charge carriers simultaneously. Unipolar components offer numerous advantages. For example, limiting to a single type of charge carrier allows for faster switching of the components. These components also show improved energy efficiency compared to their bipolar counterparts. It should be noted that unipolar components are also generally simpler to design and manufacture than bipolar components

In FIG. 2, the thermistor 130, also called “heat resistance”, is modelled by a resistance R130, the temperature of which varies according to the temperature.

The thermistor 130 is electrically connected in series with the component 120. In this way, it is travelled by the current circulating in the component 120. In addition, it can limit the current circulating in the two elements 120, 130. The thermistor 130 is also thermally coupled with the component 120, such that the temperature of the thermistor 130 is close to, otherwise equal to, the temperature of the component 120. By “close”, this means equal to plus or minus 10%, even plus or minus 5%. The thermal coupling between the two elements 120, 130 is modelled by a thermal resistance less than or equal to 1K/W. In this way, the increase of temperature of the component 120 has an effect on the thermistor 130. A thermal resistance less than or equal to 1K/W is generally quite low to guarantee a constant thermal equilibrium. A low thermal resistance, for example, less than or equal to 0.01K/W, can however be preferred.

FIG. 1 represents the resistance R120 measured at the terminals of the component 120 according to the temperature. It has a parabolic shape with a minimum around a temperature 303, that will be called “equilibrium temperature” of around 300° C. This is a temperature around which the mechanism leading to the self-heating of the component tends to stabilise. Naturally, the real temperature of the component 120 can depend on complementary factors, such as losses by Joule effect of the component 120, or also the thermal coupling with a heat sink (or a heat bath). For a temperature range less than the equilibrium temperature 303, the resistance R120 decreases according to the temperature (in other words, it has a negative gradient according to the temperature).

Thus, the component 120 has a negative temperature coefficient over a temperature range 300 less than the equilibrium temperature 303. Thus, outside of any current regulation or any thermal regulation, the component 120, subjected to an electrical current, is able to undergo a self-heating until reaching a minimum electrical resistance R120 and an equilibrium temperature 303.

Beyond the equilibrium temperature 303, the resistance R120 increases according to the temperature. In other words, the component 120 has a positive temperature coefficient over another temperature range, greater than the equilibrium temperature.

An example of so-called “maximum” temperature 304 is shown in FIG. 1. This is, for example, a temperature that the component 120 must not exceed. This can be a temperature at which a damaging can occur, or a maximum temperature supported by a protective housing 160. In order to protect from any deterioration, a so-called “setpoint” temperature 305 can be established. This is a desired operating temperature of the component 120. This setpoint temperature 305 is, for example, determined from the maximum temperature 304, and optionally from a temperature margin.

The temperature range 300 over which the component 120 shows a negative temperature coefficient therefore comprises the maximum temperature 304 and the setpoint temperature 305. The setpoint temperature 305 divides the temperature range 300 into two temperature subranges 301, 302:
a. a first temperature subrange 301 comprising all the temperatures of the temperature range 300 which are less than or equal to the setpoint temperature 305; and
b. a second temperature subrange 302 comprising all the temperatures of the temperature range 300, which are strictly greater than the setpoint temperature 305.

FIG. 2 shows the effect of the thermistor 130 on the thermal performance of the device 100. The resistance R 120 of the component 120, illustrated in FIG. 1, is reported in FIG. 2, to enable comparison. The resistance R130 of only the thermistor 130 is also reported in FIG. 2 to show the temperature control mechanism. The resistance of the device 100 (seen by the current circulating in the component 120 and the thermistor 130) corresponds to the resistance referenced “R” in FIG. 2 and is equal to the sum of the abovementioned resistances R120, R130.

The resistance R130 of the thermistor 130 is chosen to vary according to the temperature, such that the total resistance R over the second temperature subrange 302 is strictly greater than the total resistance R at the setpoint temperature 305. The total resistance R no longer shows a negative temperature coefficient over the entire temperature range 300. If it can show a negative temperature coefficient over the first subrange 301, it however shows a positive temperature coefficient over the second subrange 302. The self-heating is therefore able to not occur over the second subrange 302 which, as a reminder, comprises the maximum temperature 304. The setpoint temperature 305 becomes a new equilibrium temperature of the device 100.

During the self-heating, there can be a thermal inertia, which can act and temporarily increase the temperature of the component 120. However, as long as the margin between the setpoint temperature 305 and the maximum temperature 304 is sufficient, the temperature of the component 120 does not reach the maximum temperature 304. In the end, the temperature of the device 100 (and therefore of the component 120), finishes by stabilising in the vicinity of the setpoint temperature 305.

In FIG. 2, the resistance R130 of the thermistor 130 increases over the second temperature subrange 302. In other words, it has a positive temperature coefficient over this second temperature subrange 302. The gradient of the resistance R130 is thus chosen so as to form, around the setpoint temperature 305, a local minimum of total resistance R. The stronger the gradient of the resistance R130 is, and the better the attenuation of the self-heating over the second subrange 302 and controlling the temperature of the component 120 are. In the example illustrated, the resistance R130 of the thermistor 130 is monotone. It could however be non-monotone by preferably always enabling the formation of a local minimum of resistance R around the setpoint temperature 305.

In the example of FIG. 2, the resistance R130 of the thermistor 130 has, over the first subrange 301, a low resistance R130 before the resistance R120 over the same subrange 301. The electrical resistance R130 of the thermistor 130 over the first subrange 301 is, for example, less than or equal to 10% of the electrical resistance R120 of the component 120 over this subrange 301. In this way, the losses induced by the presence of the thermistor 130 on the electrical path are low, even insignificant.

The resistance R130 of the thermistor 130 can be constant over the first subrange 1 (such as illustrated in FIG. 2) or increasing. In the latter case, it then has a positive temperature coefficient over the first subrange 301. The resistance R130 of the thermistor 130 can also be decreasing over this subrange 301 as long as it remains preferably less than or equal to 10% of the electrical resistance R120 of the component 120 over this subrange 301. In one embodiment, the resistance R130 of the thermistor 130 increases across both the first and second subranges 301, 302. In other words, it has a positive temperature coefficient across the entire temperature range

In the example of FIG. 2, the resistance R130 of the thermistor 130 shows an increase of resistance R130 from a threshold temperature. This threshold temperature is less than the setpoint temperature 305. However, the higher the gradient of the resistance R130 of the thermistor 130 over the second temperature subrange 302 and lower and the difference between the threshold temperature on control means 130 and the setpoint temperature 305.

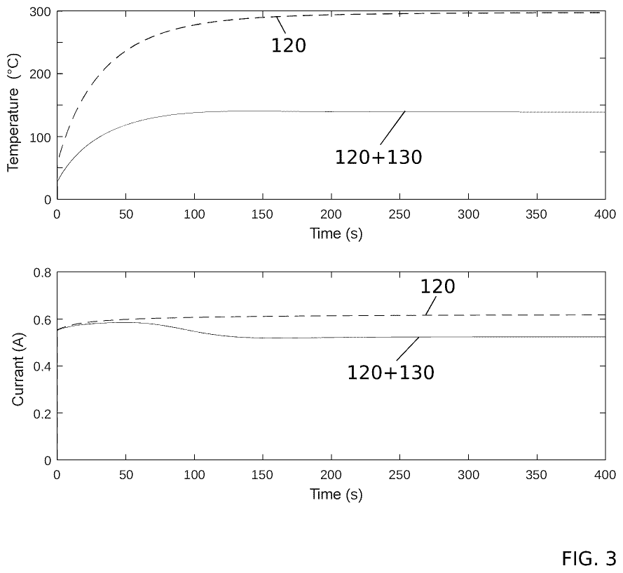

FIG. 3 represents two digital simulation results obtained from the devices 100 of FIG. 1 and of FIG. 2. In particular, these results illustrate, over time, the temperature and the current circulating in the component 120 without thermistor 130 (case of FIG. 1) and with thermistor 130 (case of FIG. 2). A reduction of the temperature is thus observed, thanks to the control means 130 of the temperature. The temperature reduction is, in particular, due to the current reduction which can be seen on the second graph, where the effect of the thermistor 130 is to limit the total current circulating in the component 120.

FIG. 4 schematically represents a first embodiment of an electronic device 100 according to the invention. The electronic device 100 is presented, on the left in the figure, without its protective housing 160, and on the right in the figure, with its protective housing 160.

In this embodiment, the component 120 is a stack of layers forming, for example, a Schottky junction. Said stack of layers comprises, for example, a diamond-based semiconductor layer and a metal layer. In this example, the thermistor 130 is assembled directly on the component 120. It is, for example, bonded on the anode or the cathode of the component 120 by means of an electrically and thermally conductive glue. Such an assembly can be qualified as “monolithic”. This embodiment has the advantage of providing a good electrical connection and a good thermal coupling (i.e. having a thermal resistance less than 0.01K/W). The thermistor 130 can also be soldered or welded or sintered on the component 120 (on the anode or the cathode) to offer a better thermal coupling and a better electrical contact.

The device 100 can also comprise two conductive electrodes 111, 112. These electrodes 111, 112 form, for example, contact pins. The component 120 and the thermistor 130 are connected in series between these two conductive electrodes 111, 112. The thermistor 130 is, for example, connected in series between the component 120 and one of the two conductive electrodes 111, 112.

The device 100 can further comprise a substrate 140, being able to be called “sole”, on which the assembly, comprising the component 120 and the thermistor 130, is fixed. The component 120 or the thermistor 130 are, for example, bonded or welded or soldered or sintered in the sole 140. The sole 140 can be conductive, thus making it possible to connect the assembly comprising the component 120 and the thermistor 130 to one of the two conductive electrodes 111, 112. For this, an electrical, and preferably mechanical contact 150, can be established between the sole 140 and one of the two electrodes 112.

The assembly comprising the component 120 and the thermistor 130 can be connected to the other conductive electrode 111 by means of bridging wires, also called wire bonding. The bridging wire(s) thus connect(s) said conductive electrode 111 with the component 120 (if it is the thermistor 130 which is connected to the sole 140) or with the thermistor 130 (if it is the component 120 which is connected to the sole). The conductive electrode 111 connected by means of bridging wire(s) can be fixed to the sole 140 by means of an electrically insulating mechanical contact 151. Thus, the sole 140 does not short-circuit the component 120.

The device 100 can comprise a housing 160, for example, bearing on the sole 140 and encapsulating the assembly comprising the component 120 and the thermistor 130.

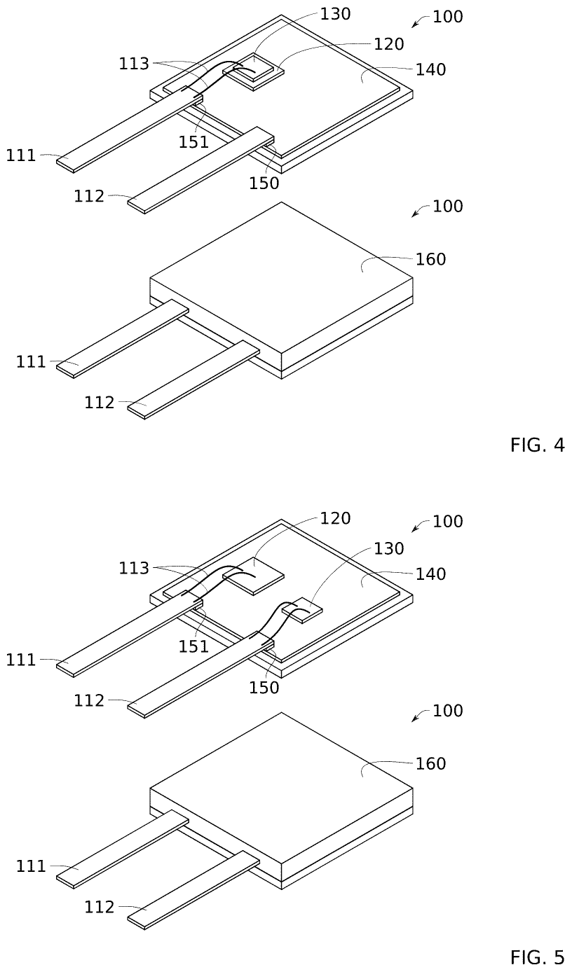

The device 100 of FIG. 5 differs from the device 100 of FIG. 4, in that the component 120 and the thermistor 130 are not in direct contact. They are electrically connected and thermally coupled by means of the sole 140. For this, the sole 140 is advantageously electrically conductive and thermally conductive.

The component 120 is, for example, directly bonded or welded or soldered or sintered on the sole 140. The thermistor 130 can also be directly bonded or welded or soldered or sintered on the sole 140. The distance between the two elements 120, 130 is such that the thermal coupling has a thermal resistance less than 1K/W and preferably less than 0.01K/W. To not short-circuit the component 120 or the thermistor 130, the conductive electrodes 111, 112 are electrically insulated from the sole 140. They can be fixed by means of electrically insulating mechanical contacts 150, 151. The component 120 can thus be connected to one of the electrodes 111 by means of bridging wires 113. The thermistor 130 can be fixed to the other electrode 112 by means of additional bridging wires. This embodiment of the device 100 has the advantage of being simple to achieve, as the component 120 and the thermistor 130 can be mounted independently from one another.

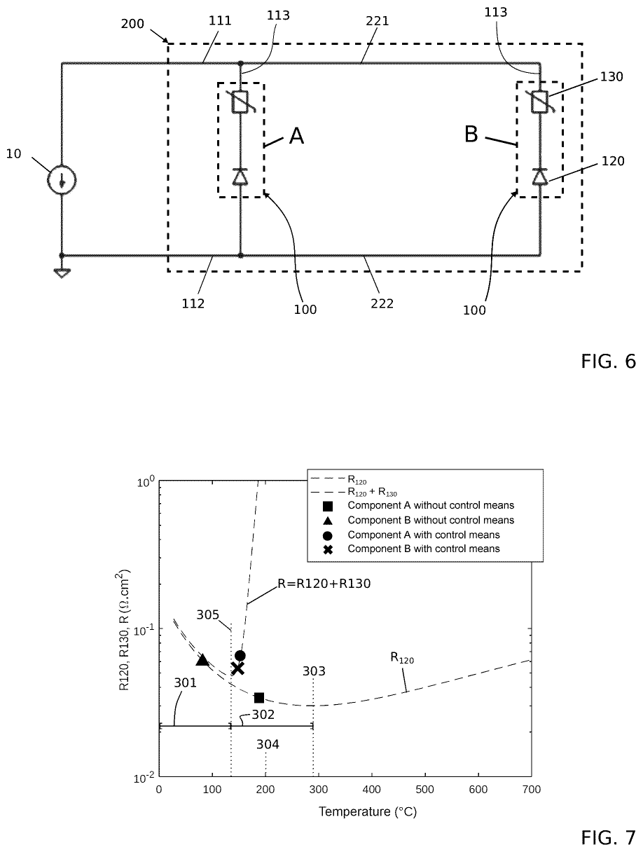

FIGS. 6 to 8 represent a paralleling of two devices 100 according to the invention forming an electronic module 200. The two devices 100 according to the invention, even if they are of the same category, are differentiated by the letters A and B.

FIG. 6 schematically represents an embodiment of a module 200, as well as the two devices A, B that it comprises. The module 200 is connected to a current source 10. The devices A, B are connected in parallel in the module 200. Thus, the electrical current delivered by the source 10 is distributed on each device A, B. The principle remains the same if the current source 10 is replaced by a voltage source. In this case, the current circulating in the module is imposed by the devices 100, the current being distributed between the devices 100 in parallel.

In the absence of the thermistors 130, the self-heating of one of the two components 120 can take the top and drain a large part, even all, of the current delivered by the current source 10. This results in the heating of the component 120 being able to lead to a thermal runaway and/or a deterioration or, as a minimum, an early ageing.

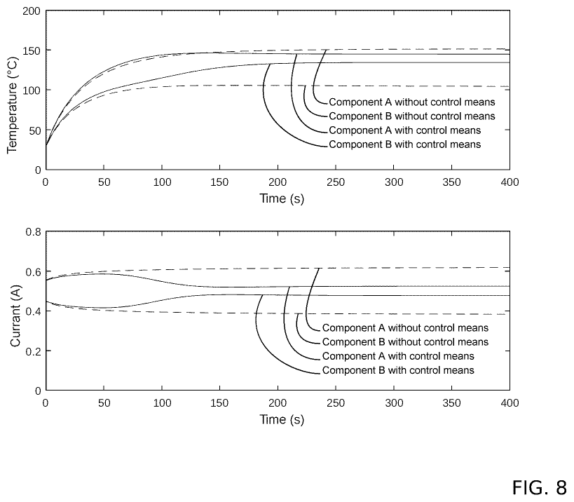

The effect of the thermistors 130 of the devices A and B is described in reference to FIGS. 7 and 8. These figures represent results of simulations for an example of a module 200 according to the invention. The devices A, B are of the same category and are supposed to be identical. These devices A, B however show slight deviations in their properties. The device A has, for example, a resistance slightly less than that of the device B. FIG. 6 represents, for each device A, B, and in the same way as FIG. 2, the state of said device A, B when the thermistor 130 is taken into account or not.

For example, in the absence of control means 130, the device A (represented by the square) undergoes a self-heating and reduces its resistance until reaching around 200° C. The device A drains a large part of the electrical current, inducing a lesser self-heating of the device B (represented by the triangle). In the simulation leading to the result of FIG. 7, the devices A and B are thermalised by a thermal bath, which makes it possible to limit the temperature reached by the device A. However, without sufficient thermalisation, the device A is thus able to lead to a greater increase of temperature, and therefore suffer from a deterioration or an early ageing.

By taking into account the thermistors 130, each device A, B will adjust its resistance to fight against the phenomenon of current focalisation, in order to preserve an even distribution of the current. Therefore, none of the devices A, B (represented by the circle and the cross) do not undergo a thermal runaway.

The effect of the thermistors 130 on each device A, B is also illustrated by FIG. 8 which represents the temperature and the current circulating in the devices A and B when the thermistor 130 is deactivated and when it is activated. The temperatures of the two devices A, B are close when the thermistors 130 are active. The temperature of each of the devices A and B is slightly greater than the setpoint temperature 305, as the current delivered by the source 10 highly heats the devices. However, thanks to the thermistors 130, the self-heating is contained. The temperatures of the devices A, B are closer, showing a better distribution of the current delivered by the source 10 between the two devices A and B. The module 200 according to the invention is therefore less likely to deteriorate or age early.

FIG. 8 shows a better distribution of the temperatures between the two devices A, B when the thermistors come into play. The electrical currents circulating in the two devices A, B are also closer.

According to a development, the module 200 can comprise at least three devices 100 connected in parallel. The principle of distributing the temperatures is thus advantageously applied to this development.

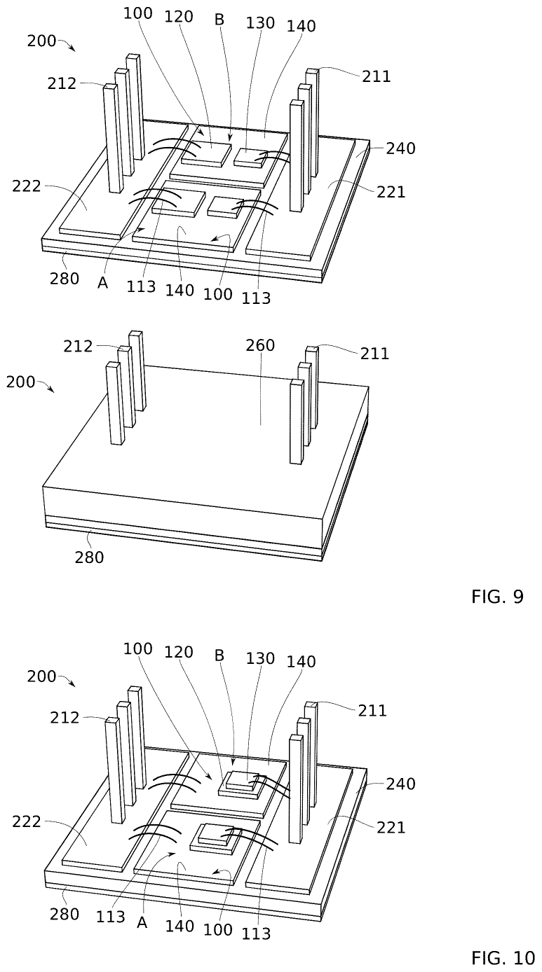

FIG. 9 schematically represents a first embodiment of an electronic module 200 according to the invention. The module 200 is presented, on the left in the figure, without its protective housing 260 and, on the right in the figure, with its protective housing 260.

In this embodiment, the devices 100 are electrically connected in parallel. For each device 100, the assembly comprising the component 120 and the thermistor 130 is electrically and thermally connected by means of the electrically and thermally conductive sole 140. This embodiment is similar to the embodiment of FIG. 4. The soles of two devices A, B are distinct from one another to avoid any electrical contact, and therefore, any short-circuit.

The devices A, B are connected in parallel by means of metal tracks 221, 222, for example, made of copper, also called “busbars”. Each device A, B is, for example, connected between the two 221, 222 by means of bridging wires 113.

The module 200 can also comprise two conductive electrodes or two groups of conductive electrodes 211, 212 forming the contact pins of the module 200. Each busbar 221, 222 can thus be connected to either of the groups of conductive electrodes 221 222. The module 200 can also comprise a support 240, against which the busbars 221, 222 and the devices A, B can extend (for example, through their soles 140).

The module 200 can also comprise a thermally conductive plate 280 making it possible to homogenise the temperature within the module. This makes it possible to limit the temperature and current dispersion of the electronic devices 100. This thermally conductive plate 280 can be thermally coupled with the support 240. It can also be thermally coupled with a heat sink.

The module 200 of FIG. 10 differs from the module of FIG. 9, in that the component 120 and the thermistor of each device A, B forms a monolithic assembly, similar to what is presented in FIG. 4. In this embodiment, the components 120 and the thermistors are in direct contact. Thus, it is no longer necessary that the soles of each device A, B are distinct. They can be combined to form one single sole. This makes it possible to thermally couple the devices 100 together. When the devices are identical, this makes it possible to further reduce the temperature difference between the components 120 of the two devices, in order to further reduce the current and temperature dispersion of the devices 100.

The invention is not limited to the embodiments described above, and extends to all the embodiments covered by the invention.

1. An electronic device comprising an electronic component, said electronic component having a resistance, said resistance having, for a temperature range, a negative temperature coefficient, said temperature range comprising a setpoint temperature dividing said temperature range into two temperature subranges, of which:
a first temperature subrange corresponding to temperatures of the temperature range less than or equal to the setpoint temperature; and
a second temperature subrange corresponding to the temperatures of the temperature range strictly greater than the setpoint temperature, wherein the electronic device comprises
a thermistor, electrically connected in series with the electronic component and thermally coupled to the electronic component, the thermistor comprising an electrical resistance varying according to the temperature, such that a total electrical resistance of the electronic device, comprising a sum of the electrical resistance of the electronic component and of the electrical resistance of the thermistor is, on the second temperature subrange, strictly greater than the total electrical resistance at the setpoint temperature.

2. The electronic device according to claim 1, wherein the electrical resistance of the thermistor is such that the total resistance of the device increases over the second subrange.

3. The electronic device according to claim 1, wherein the electrical resistance of the thermistor over the second temperature subrange is strictly greater than the electrical resistance of the electronic component at the setpoint temperature.

4. The electronic device according to claim 1, wherein the electrical resistance of the thermistor over the first temperature subrange is constant or increasing.

5. The electronic device according to claim 1, wherein the electrical resistance of the thermistor over the first temperature subrange is less than or equal to 10% of the electrical resistance of the electronic component at the setpoint temperature.

6. The electronic device according to claim 1, wherein the thermal resistance of the thermal coupling between the thermistor and the electronic component is less than or equal to 0.01K/W.

7. The electronic device according to claim 1, wherein the thermistor is bonded or welded or soldered or sintered on the component.

8. The electronic device according to claim 1, wherein the electronic component and the thermistor are made of one same part.

9. The electronic device according to claim 1, further comprising an electrically and thermally conductive sole the component being bonded or welded or soldered or sintered on the sole and the thermistor being bonded or welded or soldered or sintered on the sole.

10. The electronic device according to claim 1, wherein the component is unipolar, made from diamond, AlN, GaN, or Ga₂O₃.

11. An electronic module comprising:
the electronic device according to claim 1; and
at least one additional electronic device, connected in parallel to said electronic device.

12. The electronic module according to claim 11, wherein the electronic device and said at least one additional electronic device are thermally coupled.

13. The electronic module according to claim 11, wherein said at least one additional electronic device is an electronic device according to claim 1.

14. The electronic module according to claim 11, wherein the electronic module is a power electronics module, and wherein at least one of the devices, from among the electronic device and said at least one additional electronic device, is made from diamond.
